(19) United States
(12) Patent Application Publication
(10) Pub. No.: US 2018/0126319 A1
(43) Pub. Date: May 10, 2018

(54) METHOD FOR PRODUCING A HORIZONTAL FLOW ADSORBER AND DIVIDING WALL MODULE FOR USE IN SAID METHOD

(71) Applicant: LINDE AKTIENGESELLSCHAFT, München (DE)

(72) Inventors: Johann FERSTL, München (DE); Matthias GRAHL, München (DE); Wolfgang BADER, Ebenhausen (DE); Helko SCHNEIDER, Wolfratshausen (DE); Philipp KEIL, Regensburg (DE); Michael FIRLBECK, Tostberg (DE); Harald HENTSCHEL, München (DE)

(21) Appl. No.: 15/551,798

(22) PCT Filed: Jan. 26, 2016
(86) PCT No.: PCT/EP2016/000130

§ 371 Date: Aug. 17, 2017

(30) Foreign Application Priority Data
Feb. 25, 2015 (DE) 10 2015 002 260.1
Mar. 26, 2015 (EP) 15000897.7

(51) Int. Cl. B01D 53/04; B01J 8/00; B01J 8/02; B01J 8/04; B01J 20/28; B01J 20/30

(52) U.S. Cl. CPC B01D 53/0423; B01J 2220/66; B01J 8/002; B01J 8/003; B01J 8/008; B01J 8/0214; B01J 8/0411; B01J 20/28016; B01J 20/28052; B01J 20/3092; B01D 2259/4146; B01J 2208/00752; B01J 2208/00769; B01J 2208/0084; B01J 2208/00938; B01J 2208/025; B01J 2220/56; B01D 53/0431

(57) ABSTRACT

The method serves for producing a horizontal through flow adsorber with two adsorbents which contains two immediately adjacent packings in a horizontal or vertical container. Between the two packings there is a vertical interface. In a step (a) a vertical dividing wall is positioned on the bottom of the adsorption bed and then on each side of the dividing wall one of the two adsorbents is charged up to a first height that does not exceed the upper edge of the separating ring. In the following step (b) the vertical dividing wall is displaced upwardly until the lower edge thereof is still placed in the existing packing. Then, on each side of the dividing wall one of the two adsorbents is charged up to a second height that does not exceed the upper edge of the displaced dividing wall. Finally, step (b) is repeated until a predetermined filling height is achieved. According to the invention, the vertical dividing wall is composed of at least three dividing wall modules (6.01) that extend only over a part of the length or of the periphery of the vertical dividing wall and are movable in a vertical direction independently of one another.

The invention relates to a method according to the preamble of claim 1.

A horizontal through flow adsorber contains an adsorption bed and can be constructed as a horizontal or vertical container; that is to say it is either longer than it is high or higher than it is wide. It is constructed in such a manner that flow passes through the adsorption bed in operation horizontally. A special type of a vertical adsorber is formed by a radial adsorber. It is already known for some time to use radial adsorbers for adsorptive separation and purification methods, for instance for purifying feed air for a low-temperature air separation system. Such a radial adsorber as of the container and basket structure also used in the invention, is known from EP 402783 A2 (=U.S. Pat. No. 5,827,485). It has substantially cylindrical symmetry and contains at least two cylindrical baskets in a container that delimit an annular adsorption bed. The circular inner space within the innermost basket and the annular outer space between outermost basket and container wall serve for inflow and outflow of a fluid that is to be purified or separated.

The container height of a radial adsorber is markedly greater than the diameter thereof. Typical values are 3 to 25 m for the height and 2 to 8 m for the diameter.

U.S. Pat. No. 5,837,021 discloses the use of two immediately adjacent packings. “Immediately adjacent” is taken to mean here that no intermediate basket and no other separating device are situated between the two packings. A method for filling such a radial adsorber is also proposed that operates with a dividing wall designed as a separating ring. However, this method has surely never been employed, because it is highly complex and is associated with many disadvantages.

The object of the invention is to find a production method of the type mentioned at the outset and resources suitable therefor that permit a filling of a horizontal through flow adsorber with two or more immediately adjacent packings with comparatively low expenditure.

This object is achieved firstly by the production method according to claim 1. Accordingly, in contrast to the prior art, a one-piece ring is not used as a separating ring or—in the case of a planar interface—a one-piece wall is not used as a planar dividing wall, rather the separating ring/the planar dividing wall consists of a multiplicity of dividing wall modules that, arranged horizontally to one another, form the separating ring/the planar dividing wall. The number of dividing wall modules for a separating ring/a planar dividing wall is, for example, 3 to 25, preferably 6 to 18. They are, for example, all constructed the same and consist, in the case of a separating ring, principally of a metal sheet that is curved in a circular arc shape. The height thereof is, for example, between 0.3 m and 1 m, preferably between 0.4 m and 0.6 m.

Whereas a solid separating ring or a solid planar dividing wall require a lifting device in order to be displaced upwardly, the individual dividing wall modules are considerably more readily handlable and can be displaced upwards by hand. In the method according to the invention, furthermore, no special filling devices or other auxiliary devices are necessary which need to be introduced into the container. The production method according to the invention is particularly variable; for example, the dividing wall modules, after filling, can even be removed from the container. In this case, it must be ensured that the filling takes place in the already completed container which generally is only accessible through a manhole.

In the context of the invention, a particularly simple method for producing a horizontal through flow adsorber is provided, which requires only comparatively small expenditure.

The principle according to the invention of a segmented dividing wall can also be applied in principle to other technical fields, in particular in any container having at least one vertical interface between two layers of granular material, for example in the case of adsorbers of a different structure and in containers having catalyst beds.

Use of the method according to the invention is particularly advantageous in a radial adsorber, that is if the horizontal through flow adsorber is formed by a radial adsorber and the dividing wall by a circular separating ring, wherein the container of the radial adsorber has a cylindrical outer wall and two cylindrical baskets that delimit the adsorption bed.

It is expedient when, after the displacement of the separating ring, at the upper edge of at least one dividing wall module, at least one, in particular two, spacers are arranged that temporarily connect the dividing wall module to the outer basket, and these spacers are removed, at the start of the next step (b) and are mounted again after the displacement of the dividing wall module. Preferably, for each dividing wall module, at least two spacers are used.

The spacers permit precise adjustment of the dividing wall modules and thereby of the entire separating ring. The layer thickness of the packings can thereby be kept constant very accurately. The spacers permit maintenance of the layer thickness even when, on the inside of the outer basket, reinforcement rings or similar internals are present at defined vertical distances. The fixing of the spacers then proceeds simply above these reinforcement rings.

The spacers are preferably connected to the outer basket by being hooked in on the outer basket. The basket has, as is known from EP 402783 A2 (=U.S. Pat. No. 5,827,485), horizontal elongate holes. The outer end of the spacers is designed in such a manner that it can engage into these elongate holes. The spacers can thereby be locked into place in the basket and detached again therefrom with one hand movement in each case and nevertheless a stable connection results.

Furthermore, it is expedient if each dividing wall module has a means for tight connection to the adjacent dividing wall module; this means can be formed, in particular, by an angle strip along one of the two vertical edges of the dividing wall module. The angle of opening of the angle strip is between 30 and 120°. An effective sealing may be achieved hereby, which prevents the unwanted mixing of both adsorbents. A clear and clean interface between the two packings can be generated thereby. The angle strip can be formed by an angle plate.

The angle strip is arranged in such a manner that the vertical edge of the adjacent dividing wall module is conducted in the angle. This sealing means does not prevent thereby the vertical movability of the dividing wall modules against one another, in contrast, is an additional guide help on displacement (elevating) the dividing wall modules.

The abovementioned object is in addition achieved by a dividing wall module according to claims 6 to 8.

The invention and further details of the invention will be explained in more detail hereinafter with reference to an exemplary embodiment shown schematically in the drawings. In the drawings:

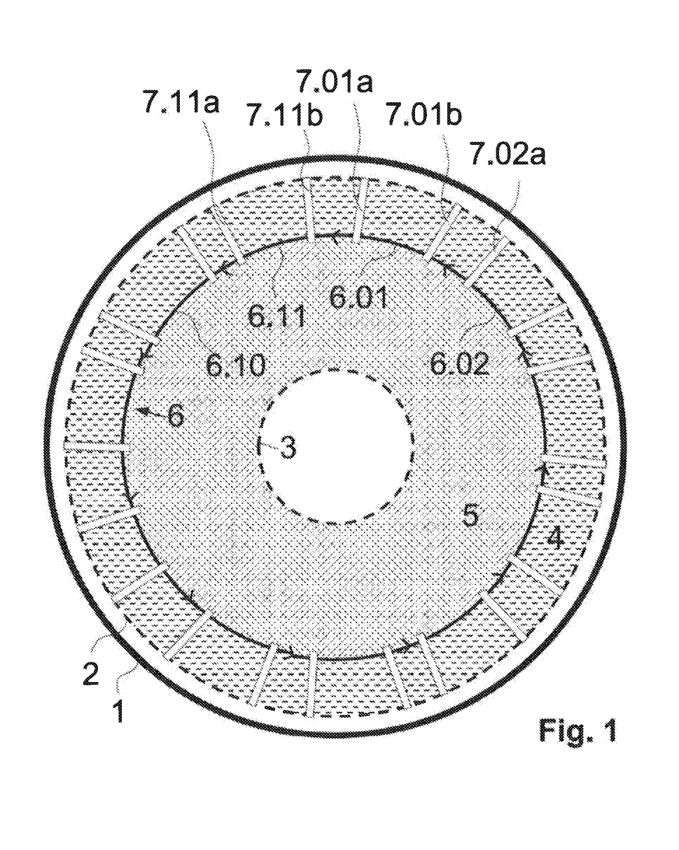

FIG. 1 shows a cross section through a partially filled radial adsorber,

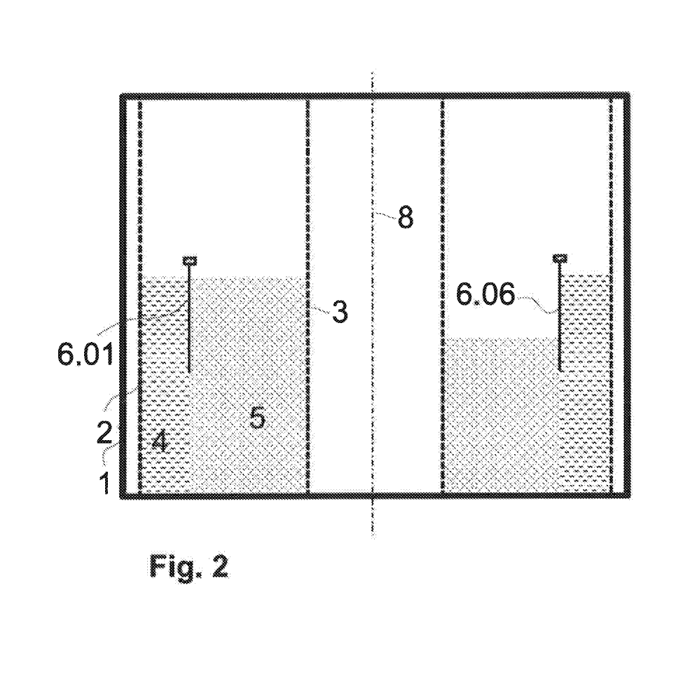

FIG. 2 shows a longitudinal section through the partially filled radial adsorber,

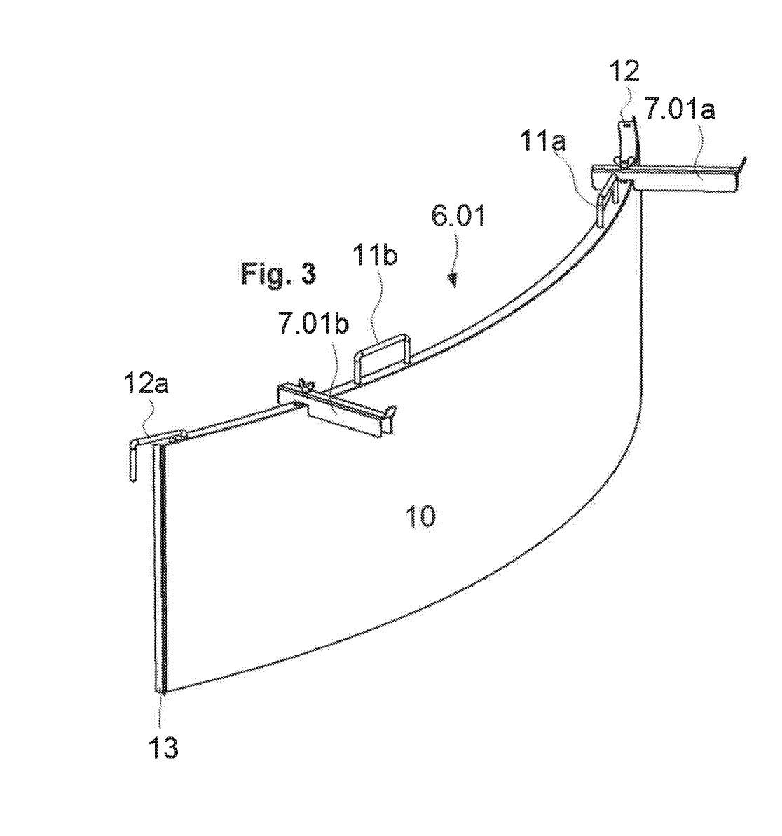

FIG. 3 shows a perspective view of a dividing wall module and

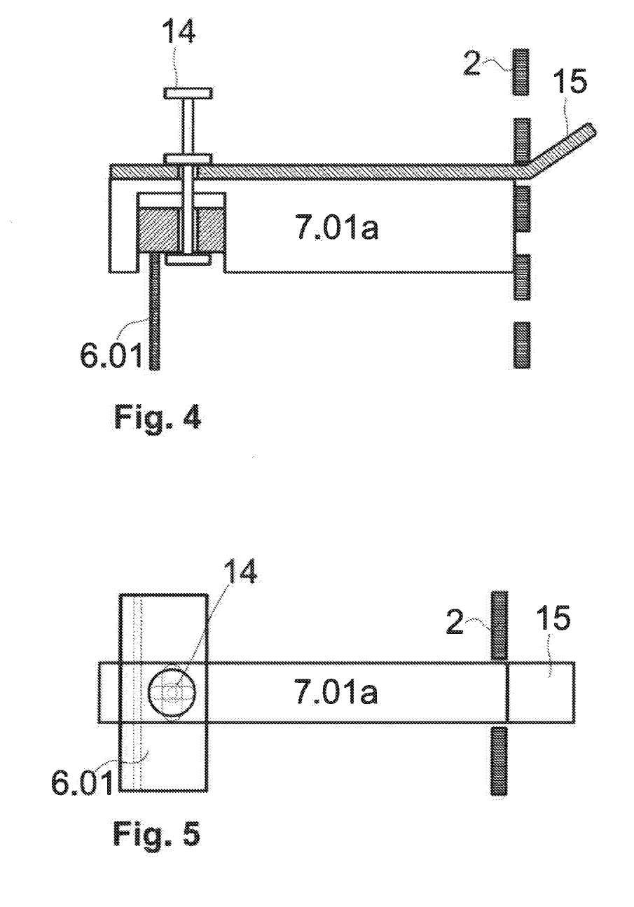

FIGS. 4 and 5 show a spacer in detail.

The horizontal image plane of FIG. 1 intersects the cylindrical outer wall 1 of the container of a radial adsorber. This, in the exemplary embodiment, contains two baskets, an outer basket 2 and an inner basket 3, which are likewise intersected by the image plane. The view thereby becomes free for a plan view onto two already partially filled packings, a first outer packing 4 and a second inner packing 5. Furthermore, the upper edge of a separating ring 6 is seen, which, in the example, consists of 11 dividing wall elements 6.01 to 6.11.

When the radial adsorber is still empty, in a step (a), the separating ring is placed on the bottom, by erecting the dividing wall elements 6.01 to 6.11 and connecting them lateraily to one another. The separating ring is adjusted relative to the outer basket 2 by means of spacers 7.01a to 7.11b. The spacers engage in the elongate holes which the outer basket has. (The inner basket likewise has such elongate holes, in order to be gas-permeable and elastic in the axial direction, for details see EP 402783 A2=U.S. Pat. No. 5,827,485)

Subsequently, via a flexible tube, a first adsorbent—in the example alugel—is charged between the outer basket 2 and the separating ring 6, until about 80% of the height of the dividing wall elements is achieved. The first adsorbent introduced forms a first part of a first packing 4.

Subsequently, previously, or simultaneously, likewise via a flexible tube, a second adsorbent—in the example a molecular sieve of the 13X type—is charged into the adjacent space between separating ring 6 and inner basket 3, generally up to about the same height as the first adsorbent. Then, the partially filled radial adsorber appears as is shown in FIG. 1.

In a first step (b), now the separating ring is displaced upwardly, but not in its entirety. In order to make a first dividing module 6.01 movable, first the spacers 7.01a and 7.01b are removed. Subsequently, the dividing module 6.01 is pulled out upwardly from the packings, and more precisely to the extent that the lower edge thereof is still firmly (approximately 10 cm) in the packing. Then, the spacers 7.01a and 7.01b are reassembled, by suspending them appropriately further up in the outer basket 2. This step is carried out for each further dividing wall module 6.02 to 6.11. Depending on the size of the adsorber and availability of assembly staff, this step can also be carried out simultaneously for two or more dividing wall modules. Subsequently, a further layer of first and second adsorbent is charged, as described above.

Step (b) is then repeated until the desired fill height is achieved. Then the dividing wall modules can be completely pulled out from the packings and individually removed from the container through a manhole. Before starting the charging, the dividing wall modules can be introduced in reverse via the manhole; it is not necessary to introduce them—as with a solid separating ring—as early as before the container is welded together.

FIG. 2 shows a detail of the height of the container in longitudinal section along the cylindrical axis 8 in the partially filled state. On the left-hand side, on the dividing wall module 6.01, step (b) is already completed for both packings 4, 5. On the right-hand side, in contrast, only the outer packing 4 is charged, and the inner is still absent.

An important advantage of the method according to the invention can be seen here. The charging of the two packings 4, 5 can—within the actual step (b)—be performed independently of one another.

An individual dividing wall module is shown in detail in FIG. 3. The substantial constituent thereof is a solid metal wall 10 that has the shape of a circular arc section. The upper edge is reinforced by a likewise correspondingly curved angle plate. At the upper edge, two hand grips 11a, 11b are fastened that considerably facilitate and accelerate the pulling out from the packings. At both ends, there are situated boreholes 12 in the upper edge. Therein, a U-shaped connection element 12a is pushed that permits a safe coupling with the adjacent dividing wall module 6.02 (see FIG. 1).

At one of the two vertical edges of the dividing wall module 6.01 there is situated an angle strip 13, the curved edge of which is connected to the edge of the metal wall, preferably by a weld connection. The internal angle of the angle strip is orientated towards the adjacent dividing wall module. When the dividing wall module is being pulled out, the vertical edge of the adjacent module can slide in the angle strip and be guided. This guiding effects at the same time a sealing against the particles of the packing, in such a manner that when they are being pulled out, no unwanted mixing of the two adsorbents occurs either.

In FIG. 3, in addition, the spacers 7.01a and 7.01b may be seen, the structure and function of which will now be described in more detail with reference to the detailed drawing in FIGS. 4 and 5.

By means of a connection 14 that may be readily opened and without a tool, the spacer is connected to the upper edge of the dividing wall module 6.01. In the exemplary embodiment, for this purpose, a conventional screw connection is utilized. Alternatively, a quick-release appliance can be used. For the connection to the outer basket, the spacer has an angled section 15, which in the assembled state engages into one of the elongate holes of the basket.

1. The method for producing a horizontal through flow adsorber with two adsorbents which contains two immediately adjacent packings in a horizontal or vertical container, wherein there is a vertical interface between the two packings, and wherein a first packing contains a first adsorbent and a second packing contains a second adsorbent that differs from the first adsorbent in the chemical composition and/or particle size thereof, wherein, in the method
(a) a vertical dividing wall is positioned on the bottom of the adsorption bed and then on each side of the dividing wall one of the two adsorbents is charged up to a first height that does not exceed the upper edge of the dividing wall,
(b) the vertical dividing wall is displaced upwardly until the lower edge thereof is still placed in the existing packing, and on each side of the dividing wall one of the two adsorbents is charged up to a second height that does not exceed the upper edge of the displaced dividing wall and
(c) step (b) is repeated until a predetermined filling height is achieved,
characterized in that the vertical dividing wall is composed of at least three dividing wall modules that extend only over a part of the length or of the periphery of the vertical dividing wall and are movable in a vertical direction independently of one another.

2. The method according to claim 1, in which the horizontal through flow adsorber is formed by a radial adsorber and the dividing wall by a circular separating ring, wherein the container of the radial adsorber has a cylindrical outer wall and two cylindrical baskets that delimit the adsorption bed.

3. The method according to claim 2, characterized in that, after the displacement of the separating ring, at the upper edge of at least one dividing wall module, at least one, spacers are arranged that temporarily connect the dividing wall module to the outer basket, wherein these spacers are removed at the start of the next step (b) and are mounted again after the displacement of the dividing wall module.

4. The method according to claim 3, characterized in that the spacers are connected to the outer basket by being hooked in on the outer basket.

5. The method according to claim 1, characterized in that each dividing wall module has a means for tight connection to the adjacent dividing wall module, wherein this means is formed, in particular, by an angle strip along one of the two vertical edges of the dividing wall module.

6. A dividing wall module, that has a planar or curved vertical plate and means for tight connection to the adjacent dividing wall module, wherein this means is formed, by an angle strip along one of the two vertical edges of the dividing wall module.

7. The dividing wall module according to claim 6, characterized in that it is temporarily connectable to one or more spacers.

8. The dividing wall module according to claim 7, characterized in that the spacers are connectable to the outer basket by being hooked in on the outer basket.
